(19) United States
(12) Patent Application Publication
(10) Pub. No.: US 2026/0088677 A1
(43) Pub. Date: Mar. 26, 2026

(54) MOTOR

(71) Applicant: LG INNOTEK CO., LTD., Seoul (KR)

(72) Inventors: Chang Hyun PARK, Seoul (KR); Kyung Ju KIM, Seoul (KR)

(73) Assignee: LG INNOTEK CO., LTD., Seoul (KR)

(21) Appl. No.: 19/111,730

(22) PCT Filed: Sep. 14, 2023
(86) PCT No.: PCT/KR2023/013791

§ 371 Date: Mar. 13, 2025

(30) Foreign Application Priority Data
Sep. 14, 2022 (KR) 10-2022-0115415

(51) Int. Cl. H02K 3/52

(52) U.S. Cl. CPC H02K 3/522; H02K 2203/09

(57) ABSTRACT

The present invention may provide a motor including a shaft, a rotor coupled to the shaft, and a stator disposed to correspond to the rotor, wherein the stator includes a stator core, an insulator coupled to the stator core, and coils disposed on the insulator, the coils include a first coil and a second coil which are separated in circuitry, the insulator includes a first region in which the first coil is disposed and a second region in which the second coil is disposed, and the motor comprises a first busbar electrically connected to the first coil and a second busbar electrically connected to the second coil.

### TECHNICAL FIELD

An embodiment relates to a motor.

### BACKGROUND ART

Generally, a rotor of a motor is rotated by an electromagnetic interaction between the rotor and a stator. In this case, a shaft connected to the rotor rotates to generate a rotational driving force.

The rotor and the stator are accommodated in a housing. The housing is a hollow cylindrical member. One side of the housing is open.

The stator may include a stator core and a coil wound around the stator core. The coil may be connected to a busbar. The busbar is supported in a busbar holder. Three busbars with a U-phase, a V-phase, and a W-phase may be provided. The busbar holder may be a mold part surrounding the busbars.

Coils may be wound in a dual manner such that the coils are separated in circuitry for fail-safe of a motor. This is to allow one coil to be used when another coil is broken. One coil is located at one side and another coil is located at the other side in a circumferential direction of a stator. Specifically, in an axial direction, either of two coils, which are separated in circuitry, occupies a half of the stator, and the other occupies the remaining half of the stator in the circumferential direction.

However, in a motor with such a configuration, a magnetic field is generated at only a half side of a stator in a circumferential direction when the motor operates, and thus there is a problem that the motor operates in a state in which the magnetic field is unbalanced.

### Technical Problem

Therefore, an embodiment is intended to solve the above-described problem and directed to providing a motor in which coils are wound in a dual manner such that the coils are separated in circuitry and a magnetic field is uniformly generated.

Objects to be solved by the present invention are not limited to the above-described object, and other objects which are not described above will be clearly understood by those skilled in the art from the following descriptions.

### Technical Solution

One aspect of the present invention provides a motor including a shaft, a rotor coupled to the shaft, and a stator disposed to correspond to the rotor, wherein the stator includes a stator core, an insulator coupled to the stator core, and coils disposed on the insulator, the coils include a first coil and a second coil which are separated in circuitry, the insulator includes a first region in which the first coil is disposed and a second region in which the second coil is disposed, and the motor comprises a first busbar electrically connected to the first coil and a second busbar electrically connected to the second coil.

The first busbar and the second busbar may be supported by the same busbar holder.

The first busbar and the second busbar may be stacked in an axial direction.

The first busbar may include a 1-1 busbar body, a 1-2 connecting terminal which protrudes from the 1-1 busbar body and is connected to the first coil, and a 1-3 connecting terminal which protrudes from the 1-1 busbar body and is connected to an external power source, the second busbar may include a 2-1 busbar body, a 2-2 connecting terminal which protrudes from the 2-1 body and is connected to the second coil, and a 2-3 connecting terminal which protrudes from the 2-1 body and is connected to the external power source, and a contact region between the first coil and the 1-2 connecting terminal may be disposed not to overlap a contact region between the second coil and the 2-2 connecting terminal in an axial direction.

The first coil may be disposed outside the second coil in a radial direction, and the 1-3 connecting terminal may be disposed outside the 2-3 connecting terminal in the radial direction.

The 1-3 connecting terminal may be located outside an outermost side of the 1-2 connecting terminal in a radial direction, and the 2-3 connecting terminal may be disposed inside an outermost side of the 2-2 connecting terminal in the radial direction.

The 1-1 busbar body and the 2-1 busbar body may be disposed to overlap in the axial direction.

The contact region between the first coil and the 1-2 connecting terminal may be coaxially disposed with the contact region between the second coil and the 2-2 connecting terminal based on a center of the busbar.

The first busbar and the second busbar may be supported by the same busbar holder, and at least any one of a plurality of 1-3 connecting terminals each of which is the same as the 1-3 connecting terminal may be disposed to overlap the busbar holder in the axial direction.

The insulator may include a guide which divides the first region and the second region.

### Advantageous Effects

According to an embodiment, since two coils separated in circuitry are wound around one tooth of a stator, there is an advantage that a uniform magnetic field is generated.

According to an embodiment, since a first busbar and a second busbar are stacked in an axial direction, there is an advantage that a first coil and a second coil wound around one tooth of a stator are easily connected.

According to an embodiment, since a contact region between a first coil and a first busbar and a contact region between a second coil and a second busbar are not disposed to overlap each other, there is an advantage that the first coil and the second coil wound around one tooth of a stator are easily connected.

### DESCRIPTION OF DRAWINGS

FIG. 1 is a view illustrating a motor according to an embodiment.

FIG. 2 is a view illustrating a stator illustrated in FIG. 1 in an axial direction.

FIG. 3 is a view illustrating a first coil wound around the stator.

FIG. 4 is a view illustrating a second coil wound around the stator.

FIG. 5 is a perspective view illustrating an insulator.

FIG. 6 is a view illustrating a first busbar, a second busbar, and a busbar module.

FIG. 7 is a view illustrating the first busbar.

FIG. 8 is a view illustrating the second busbar.

FIG. 9 is a side view illustrating the first busbar and the second busbar.

FIG. 10 is a view illustrating the first busbar and the second busbar in the axial direction.

FIG. 11 is a view illustrating the first busbar, the second busbar, and a busbar mold in the axial direction.

### MODES OF THE INVENTION

A direction parallel to a longitudinal direction (vertical direction) of a shaft is referred to as an axial direction, a direction perpendicular to the axial direction based on the shaft is referred to as a radial direction, and a direction along a circle having a radius in the radial direction from the shaft is referred to as a circumferential direction.

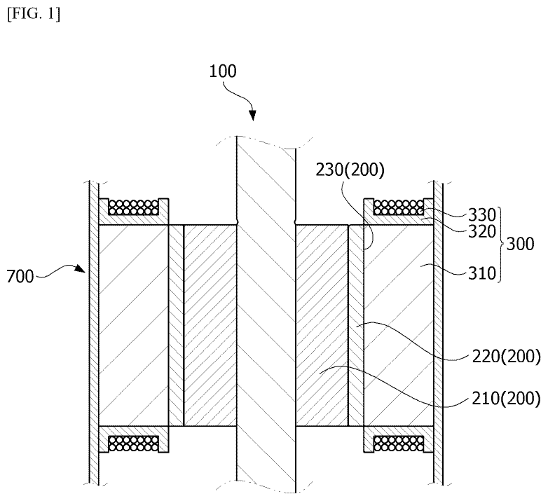

FIG. 1 is a view illustrating a motor according to an embodiment.

Referring to FIG. 1, the motor according to the embodiment may include a shaft 100, a rotor 200, a stator 300, and a housing 700. Hereinafter, the term “inward” refers to a direction from the housing 700 toward the shaft 100 which is a center of the motor, and the term “outward” refers to a direction opposite to “inward,” that is, the direction from the shaft 100 toward the housing 700. In addition, the radial direction is based on an axial center of the shaft 100.

The shaft 100 may be coupled to the rotor 200. When a current is supplied and an electromagnetic interaction occurs between the rotor 200 and the stator 300, the rotor 200 rotates, and the shaft 100 rotates in conjunction with the rotation of the rotor 200.

The rotor 200 rotates due to an electrical interaction with the stator 300. The rotor 200 may be disposed inside the stator 300.

The stator 300 is disposed outside the rotor 200. The stator 300 may include a stator core 310, an insulator 320 mounted on the stator core 310, and coils 330. The coils 330 may be wound around the insulator 320. The insulator 320 is disposed between the coils 330 and the stator core 310 and serves to electrically insulate the stator core 310 from the coils 330. The coils 330 induce an electrical interaction with a magnet of the rotor 200.

The stator 300 and the rotor 200 are disposed inside the housing 700.

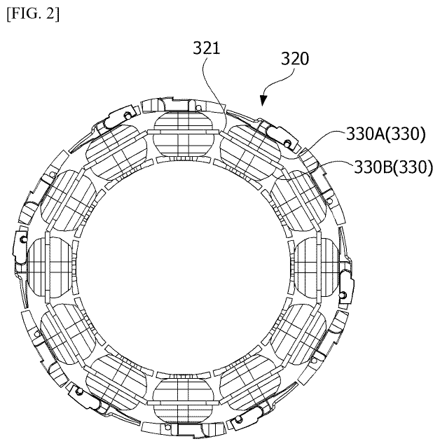

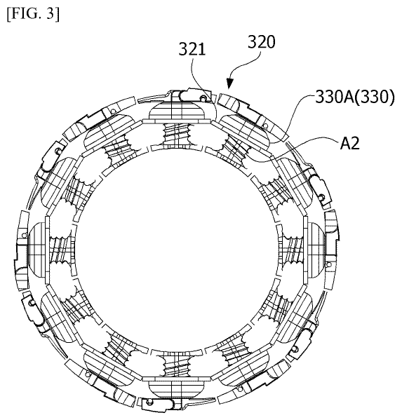

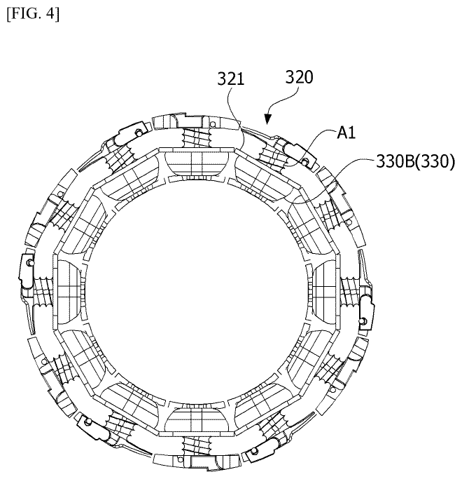

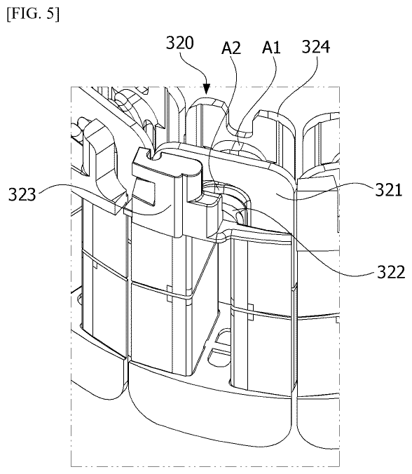

FIG. 2 is a view illustrating the stator 300 illustrated in FIG. 1 in the axial direction, and FIG. 3 is a view illustrating a first coil 330A wound around the stator 300. FIG. 4 is a view illustrating a second coil 330B wound around the stator 300, and FIG. 5 is a perspective view illustrating the insulator 320.

Referring to FIGS. 2 to 5, the stator 300 includes the first coil 330A and the second coil 330B. The first coil 330A and the second coil 330B are separated in circuitry, and when either of the first coil 330A and the second coil 330B is short-circuited, the other may be used.

The insulator 320 is disposed on each tooth of the stator core 310. In addition, both the first coil 330A and the second coil 330B are wound around the insulator 320. The first coil 330A is wound to be located outside the second coil 330B in the radial direction. The first coil 330A may be wound around each insulator 320 to be located on the stator 300 to be located outside the second coil 330B.

The insulator 320 may include an insulator body 322 around which the coils 330 are wound, an outer guide 323 disposed on an outer side of the insulator body 322, and an inner guide 324 disposed on an inner side of the insulator body 322.

The insulator 320 may include a first region A1 in which the first coil 330A is wound and a second region A2 in which the second coil 330B is wound. The first region A1 and the second region A2 may be divided by a guide 321.

The guide 321 protrudes from the insulator body 322 in contact with the coils 330 and spatially divides a space in which the first coil 330A is wound and a space in which the second coil 330B is wound. The guide 321 is located between the inner guide 323 and the outer guide 324 in the radial direction.

As illustrated in FIG. 3, the first coil 330A may be wound in the first region A1. In addition, as illustrated in FIG. 4, the second coil 330B may be wound in the second region A2.

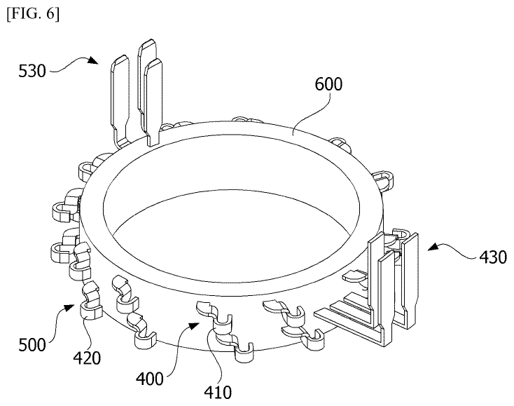

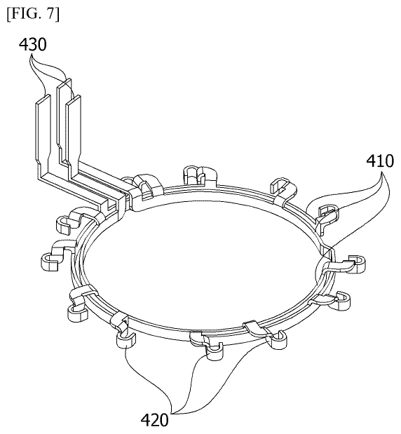

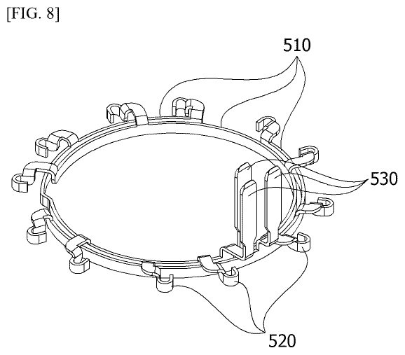

FIG. 6 is a view illustrating a first busbar 400, a second busbar 500, and a busbar holder 600, FIG. 7 is a view illustrating the first busbar 400, and FIG. 8 is a view illustrating the second busbar 500.

Referring to FIGS. 6 to 8, the first busbar 400 and the second busbar 500 may be fixed by one busbar holder 600. The first busbar 400 and the second busbar 500 may be disposed to be stacked in the axial direction. The busbar holder 600 may be formed in an annular shape, and a cross section thereof may be formed in a quadrangular shape in which a length in the axial direction is greater than a width in the radial direction.

The first busbar 400 is disposed under the second busbar 500. The first busbar 400 may be provided as three busbars with a U-phase, a V-phase, and a W-phase. Each of the first busbars 400 may include a 1-1 busbar body 410, a 1-2 connecting terminal 420, and a 1-3 connecting terminal 430.

The 1-1 busbar body 410 is an arc-shaped member having a curved surface. The 1-1 busbar body 410 may be disposed in an upright form. That is, a cross section of the 1-1 busbar body 410 may have a quadrangular shape in which a length in the axial direction is greater than a width in the radial direction.

The 1-2 connecting terminal 420 protrudes from the 1-1 busbar body 410. For example, the 1-2 connecting terminal 420 may be formed to be bent outward from an upper end of the 1-1 busbar body 410. A plurality of 1-2 connecting terminals 420 may be disposed at predetermined intervals. The 1-2 connecting terminal 420 is electrically connected to the first coil 330A. An end of the 1-2 connecting terminal 420 is formed to be bent in a hook shape to surround the first coil 330A.

The 1-3 connecting terminal 430 protrudes from the 1-1 busbar body 410. For example, the 1-3 connecting terminal 430 is formed to be bent outward from the upper end of the 1-1 busbar body 410 and then bent upward. The 1-3 connecting terminal 430 is electrically connected to an external power source. The 1-3 connecting terminals 430 of the first busbars 400 with the U-phase, the V-phase, and the W-phase may be collected and located at one location.

The second busbar 500 is located above the first busbar 400. The second busbar 500 may be provided as three busbars with the U-phase, the V-phase, and the W-phase. Each of the second busbars 500 may include a 2-1 busbar body 510, a 2-2 connecting terminal 520, and a 2-3 connecting terminal 530.

The 2-1 busbar body 510 is an arc-shaped member having a curved shape. The 2-1 busbar body 510 may be disposed in an upright form. That is, a cross section of the 2-1 busbar body 510 may have a quadrangular shape in which a length in the axial direction is greater than a width in the radial direction.

The 2-2 connecting terminal 520 protrudes from the 2-1 busbar body 510. For example, the 2-2 connecting terminal 520 may be formed to be bent outward from an upper end of the 2-1 busbar body 510. A plurality of 2-2 connecting terminals 520 may be disposed at predetermined intervals. The 2-2 connecting terminal 520 is electrically connected to the second coil 330B. An end of the 2-2 connecting terminal 520 may be formed to be bent in a hook shape to surround the second coil 330B.

The 2-3 connecting terminal 530 protrudes from the 2-1 busbar body 510. For example, the 2-3 connecting terminal 530 may be formed to be bent outward from the upper end of the 2-1 busbar body 510 and then bent upward. The 2-3 connecting terminal 530 is electrically connected to the external power source. The 2-3 connecting terminals 530 of three second busbars 500 with the U-phase, the V-phase, and the W-phase 3 may be collected and located at one location.

The 1-2 connecting terminal 420 and the 2-2 connecting terminal 520 are externally exposed from the busbar holder 600. In addition, the 1-3 connecting terminal 430 and the 2-3 connecting terminal 530 are externally exposed form the busbar holder 600. An upper end of the 1-3 connecting terminal 430 and an upper end of 2-3 connecting terminal 530 are located above an upper surface of the busbar holder 600.

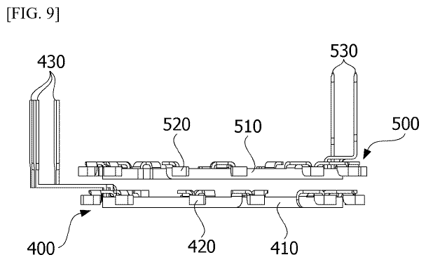

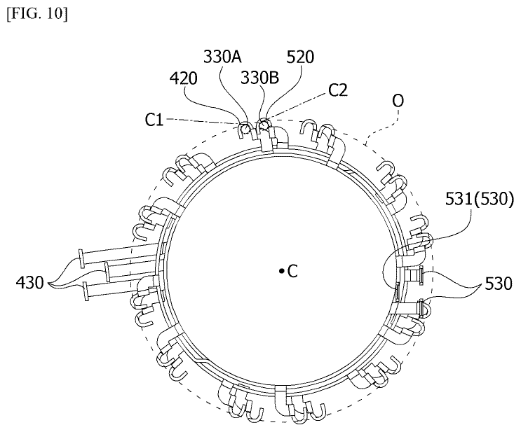

FIG. 9 is a side view illustrating the first busbar 400 and the second busbar 500, and FIG. 10 is a view illustrating the first busbar 400 and the second busbar 500 in the axial direction.

Referring to FIGS. 9 and 10, the first busbar 400 and the second busbar 500 are stacked in the axial direction. The 1-1 busbar body 410 and the 2-1 busbar body 510 are disposed to overlap in the axial direction. Accordingly, when locations of both the first coil 330A and the second coil 330B wound around one tooth of the stator core 310 are considered, the 1-2 connecting terminal 420 and the 2-2 connecting terminal 520 should be disposed such that locations thereof do not overlap.

To this end, in the first busbar 400 and the second busbar 500, a contact region C1 between the first coil 330A and the 1-2 connecting terminal 420 and a contact region C1 between the second coil 330B and the 2-2 connecting terminal 520 may be disposed to be shifted in the circumferential direction without overlapping in the axial direction.

In this case, the contact region C1 between the first coil 330A and the 1-2 connecting terminal 420 may be coaxially disposed with the contact region C2 between the second coil 330B and the 2-2 connecting terminal 520 based on an axial center C.

As described above, since the first busbar 400 and the second busbar 500 are stacked in the axial direction to correspond to the first coil 330A and the second coil 330B, there is an advantage that connection between the first coil 330A and the first busbar 400 and connection between the second coil 330B and the second busbar 500 are easy.

Meanwhile, when viewed in the axial direction, generally, the 1-3 connecting terminal 430 may be disposed at one side, and the 2-3 connecting terminal 530 may be disposed at the other side in the circumferential direction. An angle between the 1-3 connecting terminal 430 and the 2-3 connecting terminal 530 in the circumferential direction may be greater than 90° and smaller than 180°.

The 1-3 connecting terminal 430 may be located outside an outermost side of the 1-2 connecting terminal 420 in the radial direction. In addition, the 2-3 connecting terminal 530 may be located inside an outermost side of the 2-2 connecting terminal 520 in the radial direction.

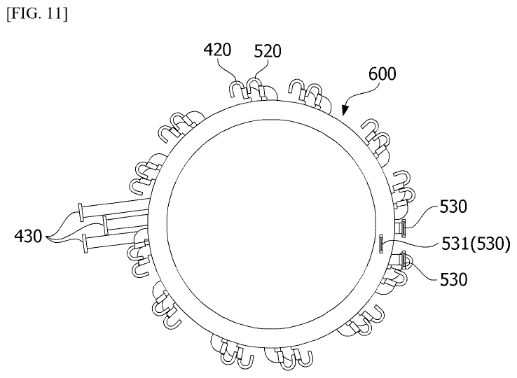

FIG. 11 is a view illustrating the first busbar 400, the second busbar 500, and the busbar holder 600 in the axial direction.

Referring to FIG. 11, the 1-3 connecting terminal 430 located at an innermost side among a plurality of 1-3 connecting terminals 430 may be disposed to overlap the busbar holder 600 in the axial direction. The corresponding 1-3 connecting terminal 430 may be exposed from the upper surface of the busbar holder 600.

As described above, in the motor according to the embodiment, the first coil 330A is connected to the first busbar 400, the second coil 330B is connected to the second busbar 500, and the first coil 330A and the second coil 330B are uniformly disposed in the circumferential direction, thereby having an advantage that a uniform magnetic field can be generated while implementing fail-safe.

The above-described embodiment can be used for various vehicle devices, home appliances, etc.

1-10. (canceled)

11. A motor comprising:
a shaft;
a rotor coupled to the shaft; and
a stator disposed to correspond to the rotor,
wherein the stator includes a stator core, an insulator coupled to the stator core, and coils disposed on the insulator,
wherein the coils include a first coil and a second coil which are separated in circuitry,
wherein the motor comprises a first busbar electrically connected to the first coil and a second busbar electrically connected to the second coil, and
wherein the connection positions of the first coil and the first bus bar and the connection positions of the second coil and the second bus bar are different in the circumferential direction.

12. The motor of claim 11, the insulator includes a first region in which the first coil is disposed and a second region in which the second coil is disposed.

13. The motor of claim 11, wherein the first busbar and the second busbar are supported by the same busbar holder.

14. The motor of claim 11, wherein the first busbar and the second busbar are stacked in an axial direction.

15. The motor of claim 11, wherein:
the first busbar includes a 1-1 busbar body, a 1-2 connecting terminal which protrudes from the 1-1 busbar body and is connected to the first coil, and a 1-3 connecting terminal which protrudes from the 1-1 busbar body and is connected to an external power source;
the second busbar includes a 2-1 busbar body, a 2-2 connecting terminal which protrudes from the 2-1 busbar body and is connected to the second coil, and a 2-3 connecting terminal which protrudes from the 2-1 busbar body and is connected to the external power source; and
a contact region between the first coil and the 1-2 connecting terminal is disposed not to overlap a contact region between the second coil and the 2-2 connecting terminal in an axial direction.

16. The motor of claim 15, wherein the first coil is disposed outside the second coil in a radial direction, and
wherein the 1-3 connecting terminal is disposed outside the 2-3 connecting terminal in the radial direction.

17. The motor of claim 15, wherein the 1-3 connecting terminal is located outside an outermost side of the 1-2 connecting terminal in a radial direction, and wherein the 2-3 connecting terminal is disposed inside an outermost side of the 2-2 connecting terminal in the radial direction.

18. The motor of claim 15, wherein the 1-1 busbar body and the 2-1 busbar body are disposed to overlap in the axial direction.

19. The motor of claim 15, wherein the contact region between the first coil and the 1-2 connecting terminal is coaxially disposed with the contact region between the second coil and the 2-2 connecting terminal based on a center of the busbar holder.

20. The motor of claim 15, wherein the first busbar and the second busbar are supported by the same busbar holder, and
wherein at least any one of a plurality of 1-3 connecting terminals each of which is the same as the 1-3 connecting terminal is disposed to overlap the busbar holder in the axial direction.

21. The motor of claim 12, wherein the insulator includes a guide which divides the first region and the second region.
